(19) United States
(12) Patent Application Publication
(10) Pub. No.: US 2009/0059418 A1
(43) Pub. Date: Mar. 5, 2009

(54) MAGNETIC HEAD AND DISK DRIVE WITH HIGH-FREQUENCY ASSISTED WRITING

(75) Inventors: Akihiko TAKEO, Tachikawa-shi (JP); Tomomi FUNAYAMA, Tokorozawa-shi (JP); Masayuki TAKAGISHI, Kunitachi-shi (JP); Masahiro TAKASHITA, Yokohama-shi (JP); Kenichiro YAMADA, Tokyo (JP); Mariko SHIMIZU, Yokohama-shi (JP); Hitoshi IWASAKI, Yokosuka-shi (JP); Junichi AKIYAMA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/196,841

(22) Filed: Aug. 22, 2008

(30) Foreign Application Priority Data
Sep. 5, 2007 (JP) 2007-230476

(51) Int. Cl. G11B 21/02

(52) U.S. Cl. 360/75

(57) ABSTRACT

According to one embodiment, a magnetic head having a head slider which holds a magnetic head unit including a heat-generating element for controlling the flying-height and a high-frequency oscillator for performing high-frequency assisted writing, and on which terminals connected to the magnetic head elements are used in the smallest number required. Terminals are mounted on the head slider and are connected to the magnetic head unit. The terminals include at least one current-supplying terminal that is connected to the heat-generating element serving to control the flying height and to the high-frequency oscillator.

### CROSS-REFERENCE TO RELATED APPLICATIONS

This application is based upon and claims the benefit of priority from Japanese Patent Application No. 2007-230476, filed Sep. 5, 2007, the entire contents of which are incorporated herein by reference.

### BACKGROUND

1. Field

One embodiment of the present invention relates to a magnetic head that has a heat-generating element for controlling the flying-height and a high-frequency oscillator for high-frequency assisted writing, and to a disk drive that comprises the magnetic head.

2. Description of the Related Art

In the field of disk drives, a representative example of which is a hard disk drive (hereinafter referred to as a disk drive), magnetoresistive (MR) or giant magnetoresistive (GMR) elements have recently been used as magnetic read elements, dramatically increasing recording density and recording capacity. Further, the disk drive has increased the recording density by about 40% each year, owing to the practical use of perpendicular magnetic recording. This is because the perpendicular magnetic recording can, in principle, achieve higher recording density than longitudinal magnetic recording.

However, ultra-high recording density can hardly be achieved due to the prominent thermal fluctuation that is inherent in magnetic recording. As a magnetic recording method that may solve this problem, there has been proposed a so-called high-frequency assisted writing method. (See, for example, U.S. Pat. No. 6,011,664 and U.S. Patent Application Publication No. 2005/0207050.) This method uses a high-frequency magnetic field in order to assist the magnetic writing, i.e., technique of writing data in a disk.

The high-frequency assisted writing method is a technique of applying a magnetic field of a frequency much higher than the recording-signal frequency to a prescribed tiny part of a magnetic disk (hereinafter referred to as a disk), thereby reducing the coercive force (Hc1) that part has in the recording-signal frequency region to half (Hc2) or less.

At the time the coercive force of the disk is thus reduced, a magnetic head applies a recording magnetic field to said part of the disk. Thus, data can be magnetically recorded on a disk that has high magnetic anisotropy energy (Ku) and, therefore, can record data at a higher density.

Some prior-art references disclose a method of applying a high-frequency magnetic field. More precisely, a high-frequency current is supplied to a coil coupled to a magnetic pole, exciting the magnetic pole and causing the magnetic pole to generate a high-frequency magnetic field, and this magnetic field is applied to a disk. If KU of the medium is increased in order to raise the recording density, the high-frequency magnetic field needs to have high frequency. With this method, however, it is difficult to raise the frequency of the magnetic field. The magnetic field is inevitably insufficient to lower the coercive force at the recording part of the medium. Consequently, it is difficult to accomplish high-frequency assisted writing.

In order to solve this problem, it has been proposed that a spin torque oscillator should be used as source of a high-frequency magnetic field. (See, for example, U.S. Patent Application Publication No. 2005/0219771.) The spin torque oscillator (STO) has, for example, a GMR or a tunneling magnetoresistive (TMR) element. The operating principle of the STO is as follows. When a current is supplied to the STO, the spins of the electrons passing through the spin injection layer is polarized. The stream of the electrons thus polarized exerts spin torque to the oscillation layer, magnetizing the oscillation layer. Thus magnetized, the oscillation layer undergoes ferromagnetic resonance, generating a high-frequency magnetic field.

In the disk drive, a read head element (e.g., a GMR element) and a write head element (e.g., a recording magnetic pole for achieving perpendicular magnetic recording) are mounted on a head main unit called a head slider (hereinafter called a slider in some cases) and spaced apart from each other. The read head element and the write head element may be called, generally as magnetic head elements.

The write head element records data on the disk or the read head element reproduces data from the disk, while the slider is flying over the rotating disk. The flying height of the slider should be as small as possible, because the closer the write head element is to the disk, the better the recording characteristic of the disk drive. During the seek operation, however, the flying height of the slider should be as large as possible, in order to avoid collision of the slider with the disk. In view of this, it has been proposed that the magnetic head should incorporate an element for controlling the flying height of the slider by utilizing the thermal expansion of the magnetic poles. (See, for example, Jpn. Pat. Appln. KOKAI Publication No. 5-20635.)

As the recording density increases in disk drives, the slider decreases in size. The slider holds not only the magnetic head elements, but also a plurality of bonding pads, i.e., terminals connecting the magnetic head elements to the power-supply circuit and the like. The area available for holding the bonding pads decreases as the slider becomes smaller, and the bonding pads should therefore be smaller. Here arises a problem. The smaller the bonding pads, the more difficult it will be to bond the slider to the suspension of the actuator of the disk drive. Further, the more components each magnetic head element has, the greater the number of the wires provided on the suspension and connecting the slider to the head amplifier. Consequently, noise is very likely to develop at the electrical junctions of the wires, and the wires may hardly be appropriately arranged due to, for example, the space insufficiency.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram explaining the wiring pattern of a magnetic head according to an embodiment of the present invention;

FIG. 2 is a diagram showing how bonding pads are arranged on a head slider according to the embodiment;

FIG. 3 is a diagram illustrating the outer appearance of the head slider according to the embodiment;

FIG. 4 is a diagram showing the major components of a disk drive according to the embodiment;

FIG. 5 is a diagram explaining the structure of magnetic head elements according to the embodiment;

FIG. 6 is a schematic representation of a high-frequency oscillator according to the embodiment;

FIGS. 7A to 7C are timing charts explaining how the disk drive according to the embodiment operates to record data in a disk; and

FIGS. 8A and 8B are diagrams explaining how to control the flying height of the head slider according the embodiment.

### DETAILED DESCRIPTION

Various embodiments according to the invention will be described hereinafter with reference to the accompanying drawings. In general, according to one embodiment of the invention, there is provided a magnetic head according to an aspect of the invention has a head slider holding magnetic head elements and terminals connected to the magnetic head elements. The terminals are used in the smallest number required so that a relatively small number of wires may connect the magnetic head elements to the head amplifier. Thus, necessary wires can be arranged in a limited space.

(Disk Drive and Configuration of the Magnetic Head)

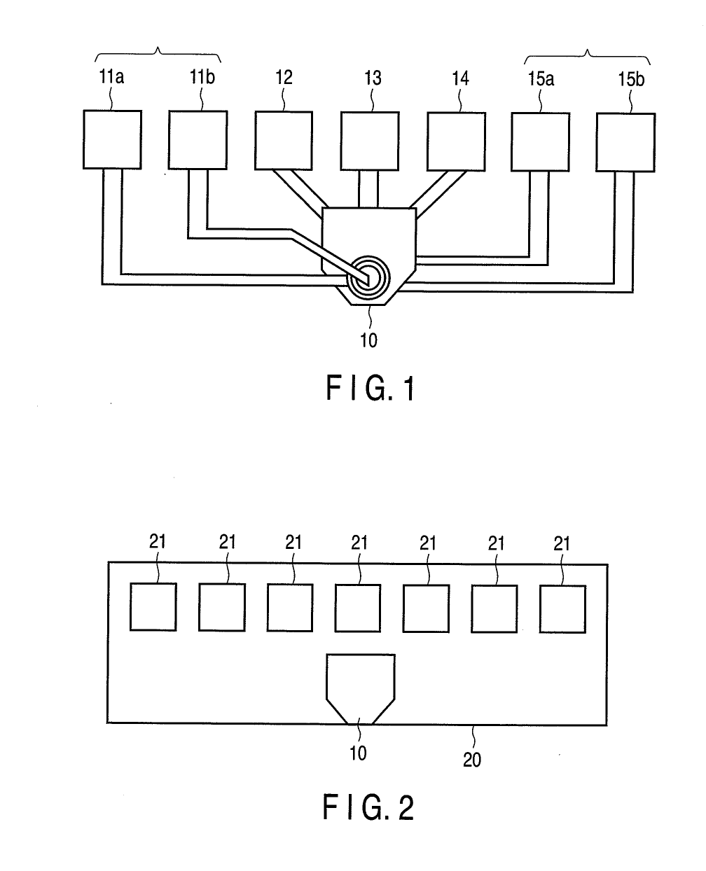

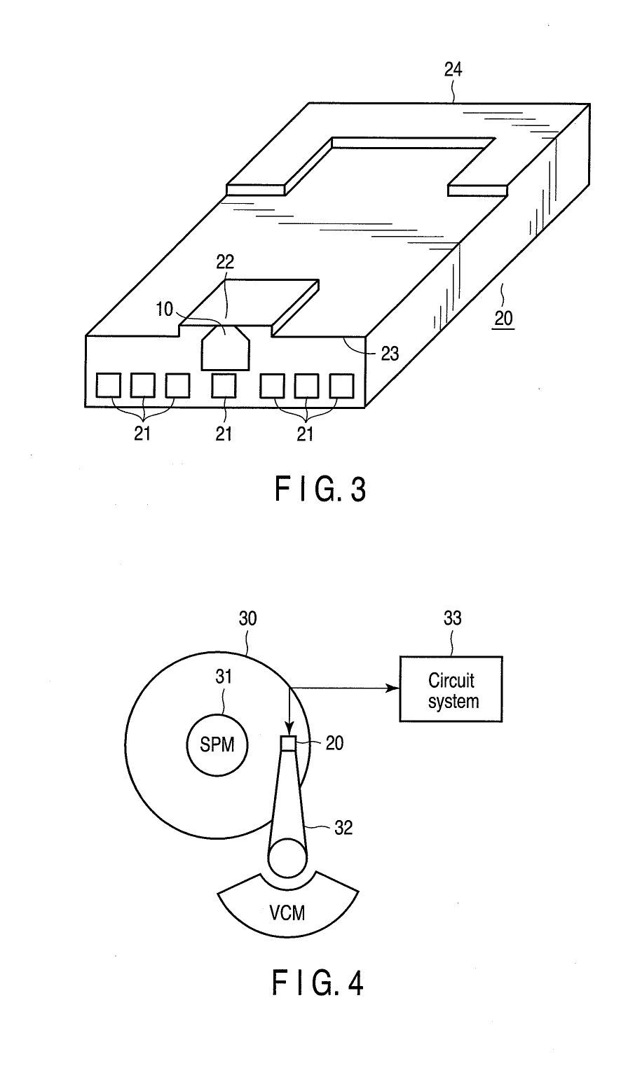

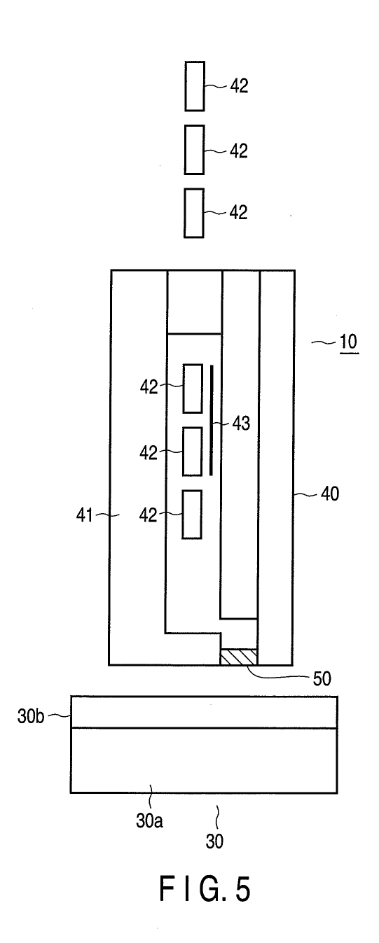

FIG. 1 is a diagram explaining the wiring pattern of a magnetic head according to an embodiment of the present invention. FIG. 2 is a diagram showing how bonding pads are arranged on a head slider according to the embodiment. FIG. 3 is a diagram illustrating the outer appearance of the head slider according to the embodiment. FIG. 4 is diagram showing the major components of a disk drive according to the embodiment. And FIG. 5 is a diagram explaining the structure of magnetic head elements according to the embodiment.

The disk drive according to the embodiment is a disk drive of perpendicular magnetic recording type. As FIG. 4 shows, the disk drive has a head slider 20, a disk 30, a spindle motor (SPM) 31, an actuator arm 32, and a circuit system 33. The head slider 20 is mounted on the actuator arm 32. The disk 30 is secured to the shaft of the SPM 31 and can be rotated.

The actuator arm 32 is a head-moving mechanism that is driven by a voice coil motor (VCM). When driven by the VCM, the actuator arm 32 moves the head slider 20 held by a suspension (not shown), radially over the disk 30. As FIG. 3 shows, the head slider 20 holds a magnetic head element 10. The magnetic head unit 10 can record data in, and reproduce data from, the disk 30, while it is flying over the disk 30 that is rotating.

The circuit system 33 includes various circuits that drive and control the magnetic head unit 10. More precisely, the circuit system 33 includes a head amplifier, a read/write channel, and a microprocessor. The head amplifier is connected to the magnetic head unit 10 by wires. The read/write channel is connected to the head amplifier and can process signals to record on the disk 30 and signals reproduced from the disk 30. The microprocessor can control the other components of the disk drive.

As shown in FIG. 5, the disk 30 comprises a substrate 30a and a perpendicular-magnetic recording layer 30b laid on the substrate 30a. When subjected to a magnetic write field from the recording magnetic pole 40 (main magnetic pole) constituting the write head element of the magnetic head unit 10, the perpendicular-magnetic recording layer 30b is controlled in terms of magnetization in the perpendicular direction. Data is thereby written to the disk 30.

As FIG. 3 shows, the head slider 20 holds the magnetic head unit 10 at the distal part. The magnetic head unit 10 is located near that surface 22 of the head slider 20, which is opposite to the disk 30. A plurality of bonding pads 21 are provided on the same side of the head slider 20 as the magnetic head unit 10 is mounted. The head slider 20 has a trailing edge 23 and a leading edge 24. As the disk 30 is rotated, air flows to the head slider 20 at the leading edge 24 and flows from the head slider 20 at the trailing edge 23. The magnetic head unit 10 is arranged at the trailing edge 23, together with the bonding pads 21.

The head slider 20 is made of composite material composed of, for example, aluminum oxide (Al₂O₃) and titanium carbide (TiC). The head slider 20 is so designed and made that it can move relative to the disk 30, either flying over the disk 30 or contacting the disk 30.

The magnetic head unit 10 has a write head element and a read head element. The read head element is a magnetic read element constituted by a GMR element or a TMR element. It detects the direction in which the perpendicular-magnetic recording layer 30b is magnetized. That is, the read head element reads the data magnetically recorded in the perpendicular-magnetic recording layer 30b of the disk 30.

As shown in FIG. 5, the write head element has a main magnetic pole 40, return path (shield) 41, excitation coil 42, heat-generating element (heater) 43, and high-frequency oscillator 50. The main magnetic pole 40 constitutes a recoding magnetic pole. The heat-generating element 43 controls the flying height of the head slider 20. The read head element and the write head element are spaced apart by an insulator (not shown) made of alumina or the like.

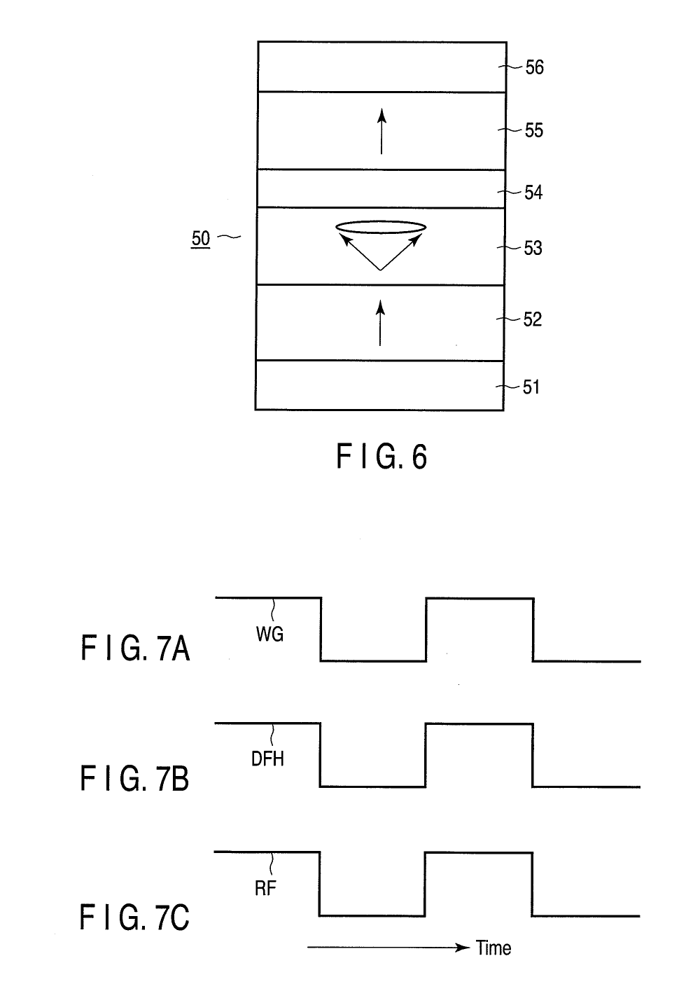

The high-frequency oscillator 50 is, for example, a spin torque oscillator (STO). As shown in FIG. 6, the high-frequency oscillator 50 has a first electrode 51 and a second electrode 56. The first electrode 51 is supplied with a current from a drive-current controller (not shown). The second electrode 56 is connected to the ground. Between the first and second electrodes 51 and 56, a multi-layer structure is interposed. The multi-layer structure comprises a bias layer 52, an oscillation layer 53, an intermediate layer 54, and a spin injection layer 55, one laid on another. The bias layer 52 is a layer that applies a magnetic bias to the oscillation layer 53. When subjected to the magnetic bias, the oscillation layer 53 oscillates at high frequency and generates a high-frequency magnetic field. The spin injection layer 55 is a layer that supplies spin-polarized electrons to the oscillation layer 53.

(Terminals of the Magnetic Head and Wiring Pattern)

FIG. 1 is a diagram illustrating the wiring pattern of the magnetic head. FIG. 2 is a diagram showing the distal part of the head slider 20 shown in FIG. 3.

In the magnetic head unit 10 of the embodiment, the excitation coil 42 is connected to two terminals 11a and 11b, and the read head element is connected to two terminals 15a and 15b. The heat-generating element 43 and high-frequency oscillator 50 are connected to a terminal 12 and a terminal 14, respectively.

The heat-generating element 43 and high-frequency oscillator 50 shares one ground terminal (GND) 13. That is, the heat-generating element 43 is connected to the terminal 12 and the ground terminal 13 and can generate heat. The heat expands or deforms the recording magnetic pole as will be described later. The high-frequency oscillator 50 is connected to the terminal 14 and the ground terminal 13. The oscillation layer 53 of the oscillator 50 can therefore generate a high-frequency magnetic field.

As FIG. 2 shows, seven bonding pads 21 are mounted on the head slider 20. These pads 31 are associated with the seven terminals 11a, 11b, 12, 13, 14, 15a and 15b of the magnetic head unit 10, respectively. Thus, the magnetic head unit 10 has wires, which are provided on the suspension holding the actuator arm 32 and which connect the seven terminals 11a, 11b, 12, 13, 14, 15a and 15b to the head amplifier included in the circuit system 33, through the bonding pads 21 provided on the head slider 20.

As described above, in the magnetic head according to the embodiment, the heat-generating element 43 serving to control the flying height of the head slider 20 shares one ground terminal 13 with the high-frequency oscillator 50. Hence, these two elements, i.e., element 43 and oscillator 50, are supplied with a current the wiring pattern connected to the head amplifier by three terminals 12, 13 and 14.

In any conventional magnetic head, the heat-generating element and high-frequency oscillator of the magnetic head unit have one terminal and one grounding terminal, each. Hence, the magnetic head unit of the conventional head has eight terminals since it includes two other elements, i.e., write head element and read head element that have two terminals each.

In the embodiment of this invention, the heat-generating element 43 and high-frequency oscillator 50 shares the same ground terminal 13, though the write head element and read head element use two terminals each, i.e., terminals 11a and 15a and terminals 11b and 15b, respectively. Hence, the magnetic head unit 10 has only seven terminals. The number of terminals used can thus be decreased without reducing the size of the bonding pads 21 even if the head slider 20 is made smaller. The bonding pads 21 provided in the numbers required can, therefore, be arranged in the limited space.

In the embodiment, the number of terminals required is reduced to a minimum by using the same grounding terminal for the heat-generating element 43 serving to control the flying height and the high-frequency oscillator 50. Nonetheless, the number of terminals required may be reduced in any other way. For example, the element 43 serving to control the flying height and the oscillator 50 may be connected in series or in parallel so that they may share two terminals, not one terminal only.

(Data Recording)

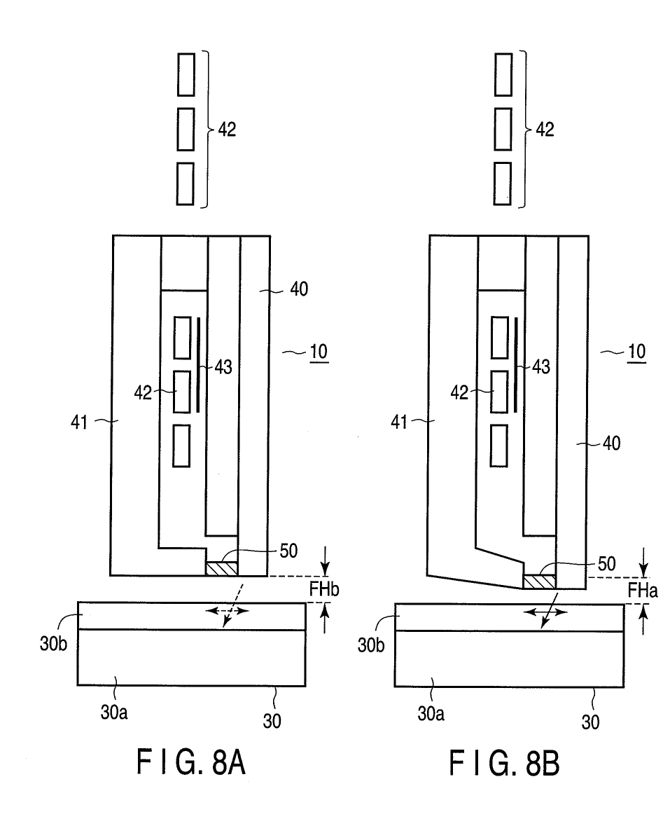

How the magnetic head unit 10 of the embodiment operates to record data will be explained, with reference to FIGS. 7A to 7C, 8A and 8B.

In the disk drive, the read/write channel included in the circuit system 33 outputs a data signal to the head amplifier at the timing of a write-gate signal WG shown in FIG. 7A. The head amplifier supplies the excitation coil 42 with a recording current that changes with the data signal, as shown in FIG. 8A or 8B. The recording current excites the main magnetic pole 40 of the magnetic head unit 10. The magnetic head unit 10 therefore performs perpendicular magnetic recording, recording the data in the perpendicular-magnetic recording layer 30b of the disk 30.

In the disk drive according to the embodiment, the head amplifier supplies a prescribed current to the heat-generating element 43 and the high-frequency oscillator 50, both included in the magnetic head unit 10, during this data recording, more precisely at the timing of the write-gate signal WG shown in FIG. 7A. Signal DFH shown in FIG. 7B defines the timing of turning on and off the heat-generating element 43. Similarly, signal RH shown in FIG. 7C defines the timing of turning on and off the high-frequency oscillator 50.

FIG. 8A shows the case where the magnetic head unit 10 undergoes no thermal expansion while no current is being supplied to the heat-generating element 43 that serves to control the flying height. By contrast, FIG. 8B shows the case where the magnetic head unit 10 undergoes thermal expansion while a current is being supplied to the heat-generating element 43 serving to control the flying height. As shown in FIG. 8B, the recording magnetic pole is deformed by the heat generated by the heat-generating element 43 and approaches the disk 30. That is, the flying height FHa, i.e., the distance between the magnetic head unit 10 provided on the head slider 20 and the perpendicular-magnetic recording layer 30b of the disk 30, decreases from the value FHb that is the distance by which the magnetic head unit 10 is spaced apart from the perpendicular-magnetic recording layer 30b while no current is being supplied to the heat-generating element 43. The recording magnetic field emanating from the main magnetic pole 40 acts more greatly on the perpendicular-magnetic recording layer 30b.

When a current is supplied to the high-frequency oscillator 50, a high-frequency magnetic field is applied to the perpendicular-magnetic recording layer 30b of the disk 30. The high-frequency assisted writing mentioned above is thereby performed on the perpendicular-magnetic recording layer 30b. At this point, the high-frequency oscillator 50 lies near the recording magnetic pole. The oscillator 50 approaches the perpendicular-magnetic recording layer 30b of the disk 30 as the current is applied to the heat-generating element 43 that serves to control the flying height. The high-frequency magnetic field emanating from the high-frequency oscillator 50 greatly acts on the disk 30, along with the recording magnetic field emanating from the main magnetic pole 40.

Thus, in the disk drive according to the embodiment, the magnetic head unit 10 applies not only the recording magnetic field emanating from the main magnetic pole 40, but also the intense high-frequency magnetic field emanating from the high-frequency oscillator 50. Data can therefore be recorded on the disk 30, owing to the high perpendicular-magnetic recording characteristic.

In summary, the present invention can provide a magnetic head having a head slider which holds a magnetic head unit including a heat-generating element for controlling the flying-height and a high-frequency oscillator for performing high-frequency assisted writing, and on which terminals connected to the magnetic head elements are used in the smallest number required.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head comprising:
a head slider configured to fly over a rotating disk;
a magnetic head unit mounted on the head slider comprising a recording magnetic pole, a magnetic read head element, a heat-generating element for controlling flying height, and a high-frequency oscillator element for performing high-frequency assisted writing; and
terminals mounted on the head slider connected to the magnetic head unit, at least one of the terminals being shared by the heat-generating element for controlling flying height and the high-frequency oscillator element.

2. The magnetic head of claim 1, wherein the terminals comprise a shared grounding terminal connected to the heat-generating element for controlling flying height and the high-frequency oscillator element.

3. The magnetic head of claim 1, further comprising bonding pads mounted on the head slider, the bonding pads connecting the terminals and elements comprised in the magnetic head unit to a circuit configured to supply a current to the elements comprised in the magnetic head unit.

4. The magnetic head of claim 1, wherein the high-frequency oscillator element is a spin torque oscillator element positioned near the recording magnetic pole.

5. The magnetic head of claim 2, wherein the high-frequency oscillator element is a spin torque oscillator element positioned near the recording magnetic pole.

6. A disk drive comprising:
a disk configured to rotate;
a head slider configured to fly over a rotating disk and to hold a magnetic head unit comprising a recording magnetic pole, a magnetic read head element, a heat-generating element for controlling flying height, and a high-frequency oscillator element for performing high-frequency assisted writing;
terminals mounted on the head slider and connected to the magnetic head unit, at least one of the terminals being shared by the heat-generating element for controlling flying height and the high-frequency oscillator element; and
a recording unit configured to supply a current to the recording magnetic pole, the heat-generating element for controlling flying height and the high-frequency oscillator element, in order to perform magnetic recording on the disk.

7. The disk apparatus of claim 6, wherein the terminals comprise a grounding terminal connected to, and shared by, the heat-generating element for controlling flying height and the high-frequency oscillator element.

8. The magnetic head of claim 6, further comprising bonding pads mounted on the head slider, the bonding pads connecting the terminals and elements comprised in the magnetic head unit to a circuit that is configured to supply a current to the elements comprised in the magnetic head unit.

9. The magnetic head of claim 6, wherein the high-frequency oscillator element is a spin torque oscillator element positioned near the recording magnetic pole.

10. The magnetic head of claim 7, wherein the high-frequency oscillator element is a spin torque oscillator element arranged positioned the recording magnetic pole.

11. The magnetic head of claim 6, wherein the recording unit is configured to supply a current to the recording magnetic pole, the heat-generating element for controlling flying height and the high-frequency oscillator element at the same time, in order to record data on the disk.
